(19) United States
(12) Patent Application Publication
(10) Pub. No.: US 2020/0024757 A1
(43) Pub. Date: Jan. 23, 2020

(54) Production of Alkali Metal Hydroxide, Chloride and Sulfate via Electrodialysis and Subsequent Downstream Processing

(71) Applicant: K. N. Mani, Basking Ridge, NJ (US)

(72) Inventor: K. N. Mani, Basking Ridge, NJ (US)

(21) Appl. No.: 16/455,300

(22) Filed: Jun. 27, 2019

Related U.S. Application Data
(60) Provisional application No. 62/764,151, filed on Jul. 20, 2018.

(51) Int. Cl. C25B 1/34; B01D 61/42

(52) U.S. Cl. CPC C25B 1/34; B01D 2325/26; B01D 61/422

(57) ABSTRACT

An energy efficient, environmentally greener process that converts alkali salts to various salt/fertilizer compounds and chloride/sulfate compounds is disclosed. The process uses bipolar membrane electrodialysis or multi-compartment electrolysis to initially convert potassium, sodium and lithium salts to their respective alkali and acid components. The alkali is subsequently reacted with sulfur or phosphoric acid or other acid to produce thiosulfate, phosphate, acetate or other salt products. The acid coproduct is concurrently converted to compounds such as calcium chloride, lysine hydrochloride, ammonium sulfate through solvent extraction and subsequent stripping of the loaded solvent with an appropriate alkali.

### FIELD OF THE INVENTION

This invention discloses an energy efficient and environmentally green process route for the conversion of an alkali metal chloride to alkali metal hydroxide, a different alkali metal salt and a different chloride salt as coproducts. The process can also be used to convert an alkali metal sulfate to alkali metal hydroxide, a different alkali metal salt and a different sulfate salt as coproducts. More specifically, the invention uses bipolar membrane electrodialysis to convert an alkali metal salt to alkali metal hydroxide and an acid coproduct and discloses (a) the conversion of the acid product to a concentrated salt product through extraction of the acid into an organic extractant and its back extraction through stripping of the loaded solvent with a suitable alkali, thereby regenerating the organic extractant, while producing the salt at a high concentration and of improved purity (b) Purifying the alkali metal hydroxide coproduct to remove the contaminant anions through a chromatography or ion retardation process and concentrating the purified alkali metal hydroxide (c) The conversion of alkali metal hydroxide to a (different) alkali metal compound without the need for upstream purification step to remove the contaminating anion(s) or pre-concentration of the alkali metal hydroxide.

### DESCRIPTION OF THE PRIOR ART

Conventionally, alkali and chloride/sulfate/phosphate and other salts are made from commercially purchased acid or alkali and performing reactions on them; i.e. reacting the alkali metal hydroxide with an acid or vice versa. For example, dipotassium phosphate (K₂HPO₄) or potassium thiosulfate (K₂S₂O₃) are made from high purity concentrated potassium hydroxide (KOH, 45-50 wt % strength) through reaction with phosphoric acid (H₃PO₄), and elemental sulfur (S) plus oxygen (O₂) respectively. Similarly salts such as calcium chloride (CaCl₂)) or ammonium sulfate ((NH₄)₂SO₄) are made by reacting concentrated acid of high purity with lime/limestone and ammonia respectively. The processes require the manufacture/handling of the concentrated, hazardous chemicals (KOH, NaOH, HCl, H₂SO₄ etc.) as well as their transport to the salt production site(s).

There is need for novel process routes for the production of said chemicals, wherein the overall capital and energy requirements are reduced dramatically and the production, handling and transport of concentrated (hazardous) chemicals is minimized or eliminated.

The first step in my novel process is the use of bipolar membrane electrodialysis to generate the acid and alkali (base) from the starting salt raw material. Electrodialysis using bipolar membranes is an energy-efficient route for the conversion of alkali metal salts to alkali metal hydroxides and acids. The process uses a bipolar membrane (BM) in conjunction with a cation selective membrane (CM) and an anion selective membrane (AM), said membranes being separated by compartments containing salt, (S) acid (A) and base (B) solutions. The assembly comprising multiple sets of the membranes and the solution compartments is termed an electrodialysis water splitter cell stack. The process is driven by a direct current driving force.

In the process (also termed bipolar membrane water splitting or bipolar membrane electrodialysis, BED) a salt such as sodium chloride, potassium chloride or lithium chloride (NaCl, KCl, LiCl) is converted to the corresponding alkali metal hydroxide (NaOH, KOH, LiOH) and hydrochloric acid (HCl). Specifically, the hydroxyl ions generated at the bipolar membrane—by the forced dissociation of water under a direct current driving force—combine with the cationic component of the salt to generate the alkali metal hydroxide.

Concurrently the hydrogen ions generated at the bipolar membrane combine with the chloride ions from the salt to form hydrochloric acid (HCl). U.S. Pat. No. 5,139,632 for example describes the operation of the three compartment electrodialysis cell in greater detail.

An alkali metal sulfate salt, e.g. sodium sulfate (Na₂SO₄) may be converted to sodium hydroxide and sulfuric acid (H₂SO₄) in a similar manner, and is disclosed in U.S. Pat. No. 4,504,373.

In certain cases a two compartment cell comprising bipolar and cation membranes may be used to generate an alkali metal hydroxide and an acid/salt mixture, as also described in U.S. Pat. No. 4,504,373. Such a cell arrangement, for example, may be used to convert sodium sulfate to sodium hydroxide, and a mixture comprising sodium sulfate and sulfuric acid.

A multi-compartment cell comprising a bipolar membrane and two (or more) cation membranes may be used to generate an alkali metal hydroxide and acid/salt mixture containing a reduced amount of salt, as disclosed in U.S. Pat. Nos. 4,608,141, 4,536,269.

An electrolysis process may also be used to generate said acid and base, particularly when converting a salt such as sodium sulfate (Na₂SO₄). The electrolysis process uses a set of electrodes (cathode, anode), in place of the bipolar membrane to generate the acid, base products, as shown in U.S. Pat. No. 3,135,673.

By way of comparison, the electrolysis process involves electrochemical oxidation/reduction reactions at the electrodes, while the bipolar membrane based electrodialysis process involves only a simple rearrangement and separation of the ions in solution. The electrolysis cell generates hydrogen and oxygen as byproducts, while an electrodialysis cell does not. As a result the electrodialysis route for alkali metal hydroxide and acid production consumes ˜40% less energy than the electrolysis route.

Electrodialysis is also environmentally greener since the process, for example when processing alkali metal chloride, does not produce chlorine gas.

A large number of issued patents cover the bipolar membrane water splitting and electrolysis technologies in great detail, and can be found through a search on the internet.

A problem with the electrodialysis and electrolysis processes is that the products (NaOH, KOH, HCl, H₂SO₄) are relatively dilute, typically <7 wt % for HCl, <10 wt % for H₂SO₄ and ˜15 wt % for NaOH, KOH. Additionally, there are certain amounts of the salt ions present in the acid and base products, e.g. Na⁺ or K⁺ in the acid product and Cl⁻ or SO₄⁼ in the alkali metal hydroxide product. Since the acid and base are produced together in the electrodialysis (and electrolysis) cells, both of them need to be economically converted to marketable products in order for said processes to be commercially viable. While the base product (NaOH, KOH) can be purified and concentrated at a reasonable cost, the same is not true for the acid product. At the current state of the art one therefore has to have a customer who can use the dilute acid, and the BED facility has to be located close to this user. Presently there are few uses for the dilute acid.

Dilute HCl can be extracted from aqueous solutions using certain organic extractants. Jamal Stas & Hala Alsawaf (Periodica Polytechnica Chem. Eng. 60(2), 130-135, (2016)) for example describe the extraction/purification of HCl using tertiary amine/kerosene in the presence of 1-octanol or tributyl phosphate. The HCl laden solvent was then stripped to recover the HCl using water. In the net, the process results in a dilute acid similar in strength to the starting material.

The problem related to the dilute acid product has, in effect, stymied the further advancement of the electrodialysis technology despite its advantages of low energy cost and being environmentally safer.

### BACKGROUND OF THE INVENTION

The BED process (or the equivalent electrolysis process, as described later in this disclosure) typically generates ˜12-18% KOH, 10-15 wt % NaOH, 5-7% HCl, and ˜10 wt % H₂SO₄. The products from the (three compartment) process are very clean, except for (say with KCl splitting) the presence of certain amounts of chloride in KOH and potassium in HCl. The anion content (Cl⁻, SO₄⁼) in alkali hydroxide product is typically <1,000 ppm; as is the cation content in the acid product (<1,000 ppm).

When the acid and base are produced in a cell comprising bipolar membrane and one or more cation membranes, the acid product would have substantial amount of unconverted salt, typically, 10 wt % or more.

In order to make the products useful to a wide range of customers at considerable distances one needs to purify them to remove the contaminant ions and concentrate the purified acid, base to commercial strength; typically 32-98 wt % for the acid and 45-50 wt % for the base. Even at that the products marketed are classified as hazardous to handle, transport and store onsite.

Concentrating the acid product is difficult and presently uneconomical. The acids are corrosive, requiring the use of expensive materials of construction. Significant energy input is also required. Economic removal of the contaminant alkali cation (Na⁺, K⁺) from the dilute acid feed is also quite difficult or impossible.

Converting the dilute acid onsite to other products of marketable quality is also presently uneconomical. Neutralization of the HCl with lime or limestone, for example, will yield a calcium chloride (CaCl₂) solution at ˜10 wt % strength. The dilute salt solution would subsequently need to be concentrated to 30-36 wt % via multiple effect evaporation in order to be marketable. The latter step is energy and capital intensive. The process also does not remove the Na⁺, K⁺ contaminant from the final product. Removal of said contaminant is likely important for food and related applications.

Pre-concentration of the dilute HCl to 31-37 wt % (20-23°Be) and subsequent neutralization with lime/limestone is another option for making a marketable calcium chloride product. Unfortunately this is also difficult and expensive due to the occurrence of a maximum boiling azeotrope at ˜20 wt % HCl. Furthermore the acid is corrosive, necessitating the use of carbon equipment or expensive alloys, which further add to the complexity and the overall cost of the process.

Production of a sulfate product from dilute H₂SO₄ via neutralization to generate a marketable product, e.g. 40 wt % ammonium sulfate ((NH₄)₂SO₄), would pose a similar problem as with calcium chloride; the resultant dilute sulfate solution from the neutralization step requiring an energy and capital intensive concentration step.

A suggested alternative route for producing a concentrated salt product is direct neutralization of the acid within the acid loop of the water splitter, thereby avoiding dilution of the product with water. For example, U.S. Pat. No. 6,110,342 describes the production of a concentrated lysine hydrochloride salt (lysine.HCl) by neutralizing the HCl in-situ (i.e. within the acid loop) through direct injection of a lysine base solution. Such a process however is only applicable to situations where the base feed as well as the salt product are both soluble in water. The presence or formation of precipitates within the cell stack, as would occur with the use of lime/limestone (for producing calcium chloride), will make the process unworkable due to the plugging/fouling of the internals.

Even where the base used and the resulting salt products remain soluble, as is the case with lysine/lysine.HCl, or ammonia/ammonium chloride or ammonia/ammonium sulfate, there are potential operational problems due to the high osmotic pressure of the salt solutions. Any internal leakages within the cell stacks will lead to contamination of the alkali co-product and render the process ineffective. Diffusional transport can also lead to losses and product contamination.

Additionally, none of the current routes for converting the acid product from the BED or electrolysis processes to salts of commercial strength are capable of removing the alkali metal contaminant in the product.

As for the alkali products from the electrodialysis or electrolysis step, they may be purified and concentrated to commercial strength (45-50 wt % KOH, NaOH) as disclosed in U.S. Pat. No. 6,482,305 B1. Marketable salt products are then made by reacting the commercial strength KOH (or NaOH) with an appropriate reactant. For example, production of potassium thiosulfate (K₂S₂O₃) is achieved by reacting 45-50 wt % KOH with elemental sulfur and oxygen. Dipotassium phosphate (K₂HPO₄) is similarly made by reacting 45-50 wt % KOH with phosphoric acid (H₃PO₄), as are most other salt products.

Concentration of alkali metal hydroxide solutions however requires a fair amount of capital and energy input. Also the KOH, NaOH product needs to be transported to the manufacturing sites of these chemicals, which is a hazardous operation.

A simpler, greener, energy efficient, and lower cost option for converting the acid and base from the BED and electrolysis processes to commercially salable products is therefore needed.

### A BRIEF DESCRIPTION OF THE DRAWINGS

FIG. 1 shows a block diagram of the process for converting the feed salt to a different alkali metal salt and a chloride salt

FIG. 2(a) shows the bipolar membrane electrodialysis (BED) cell for converting the feed salt solution to the corresponding acid and alkali solutions

FIG. 2(b) shows a (four compartment) electrolysis cell for converting the feed salt solution to the corresponding acid and alkali solutions.

FIG. 3 shows the extraction process for converting the dilute hydrochloric acid (HCl) from the BED Cell to calcium chloride (CaCl₂).

FIG. 4 shows a block diagram for converting the potassium hydroxide (KOH) alkali to potassium thiosulfate (K₂S₂O₃).

### SUMMARY OF THE INVENTION

I have invented a novel process that requires minimal expenditure of energy for converting the acid from the electrodialysis and electrolysis processes into products of commercial strength and quality. This innovation, in turn, allows the production of environmentally safe products at locations farther from the end-user(s).

Concurrently I have devised novel ways for generating alkali metal compounds from the less concentrated alkali hydroxide generated by the BED process. These processes do not require an upstream purification of the alkali hydroxide. The process routes devised for accomplishing them are energy efficient, cost-effective and environmentally greener.

The first step in the process is the use of bipolar electrodialysis (BED) cell stack to convert a soluble salt to its corresponding acid and alkali (base) components. Each BED cell unit in these cell stacks (BPCS) comprise a cation-selective, an anion-selective, and a bipolar membrane. A large number of cells, typically 50-150 are assembled between a set of electrodes to form the BPCS assembly. The BED process occurs in an aqueous medium and uses these ion exchange membranes and an electrical driving force to effect the separation and rearrangement of the raw materials, for example KCl and water, into acid and alkali (base) products. Chlorine (Cl₂) is not produced in this process.

An electrolysis process may also be used to convert a soluble salt to its corresponding acid and alkali (base) components. The process however requires the electrodes to split the water molecules, and a set of cation selective and anion selective membranes for producing the acid and base products. The process generates hydrogen and oxygen gases as byproducts and hence requires a greater amount of energy input than BED. For converting the chloride salts one also needs to add a buffer compartment in the cell in order to prevent the production of chlorine gas.

A novel solvent extraction process is herein disclosed for converting the dilute acid (e.g. HCl, H₂SO₄ or HNO₃ (nitric acid)) from the water splitting and electrolytic processes to a salt product at a higher concentration and purity. The process involves contacting the dilute acid with a relatively water insoluble basic (or nearly basic) solvent, thereby transferring the acid values to the solvent phase. Essentially all of the acid values may be transferred to the solvent (organic) phase, leaving behind the water, small amounts of un-extracted acid and the contaminant ions (Na⁺, K⁺) in the raffinate. The loaded solvent is then stripped of its acid content by reacting with the appropriate alkali, thereby obtaining a salt product at a substantially higher concentration; and concurrently regenerating the solvent for reuse in the extraction step. Any cationic impurities in the acid feed (e.g. K⁺ in HCl) are excluded from the loaded solvent. Consequently the salt product is essentially free of the cationic impurity present in the acid feed. The process thereby produces salt solutions that are of substantially high concentration and of high purity.

The raffinate from the extraction step, i.e. water containing any un-extracted acid and ion contaminant (K⁺, Na⁺), may be suitably purified to remove/recover its salt content and recycled as water makeup to the electrodialysis/electrolysis cell. The recovery of the raffinate water for reuse provides substantially all the water make-up requirements for the acid loop of the BED or electrolysis process.

To produce calcium chloride salt, for example, the HCl-loaded solvent is contacted with a suitable alkali such as lime or limestone, whereby a calcium chloride solution at high concentration (31-38 wt. %) is obtained; with the concurrent regeneration of the solvent. The regenerated solvent is forwarded to the acid extraction step and the cycle repeats.

Other soluble chloride salts at high concentration can be obtained in a similar manner. For example lysine.HCl may be produced by extracting the acid from the loaded solvent using a lysine base solution as the reactant. A concentrated lithium chloride solution may be generated in a similar manner by reacting the acid laden solvent with lithium hydroxide or carbonate. In each case the regenerated solvent is recycled back to the acid extraction step and the cycle repeated.

To produce the sulfate salt, e.g. ammonium sulfate, the H₂SO₄ from the electrodialysis or electrolysis step is extracted with a relatively water insoluble basic (or nearly basic) solvent. The loaded solvent is subsequently contacted with ammonia gas or a concentrated ammonia solution, whereby a reactive back extraction of the acid as ammonium sulfate solution at high concentration occurs; with the concurrent regeneration of the solvent. The regenerated solvent is forwarded to the acid extraction step and the cycle repeats.

Other soluble chloride, sulfate and nitrate salts may be obtained in a similar manner

Preferred solvents for the process are long chain amines containing 18-24 carbon atoms such as tricapryl amine, tri-octyl amine, tri-decyl amine, tri-dodecyl amine, tri-lauryl amine, mixed long chain amines such as Alamine 304-1, Alamine 336 sold by BASF, trioctyl phosphine oxide (TOPO), and ionic liquids such as Cyphos 104 etc. The solvent may be diluted with co-solvent such as a long chain alcohol, and/or similar sparingly soluble co-solvent such as kerosene. Examples of long chain alcohols are 1-octanol, 2-6 dimethyl 4-Heptanol and similar material containing 8-10 carbon atoms.

Major advantages of the inventive route for processing (for example) the dilute HCl are (a) a concentrated solution of calcium chloride is obtained directly; the product being of marketable quality at 31-38 wt % strength. (b) Exclusion of the salt impurity from the product (c) Water requirements for the BED step are reduced; the bulk of the water in the (4-7 wt. %) HCl being recovered for reuse.

No energy input is needed for producing the salts. In fact there is a need for cooling in the stripper unit, due to the exothermicity of the reaction of lime with the HCl in the loaded solvent.

As for the base co-product, the product (˜15 wt % wt % NaOH, KOH) from BED/electrolysis may be purified and concentrated to commercial strength, and used downstream in the production of chemicals. The purification involves a chromatography step to remove the contaminating anion (e.g. Cl⁻ in KOH), as disclosed in U.S. Pat. No. 6,482,305 B1. The purified base is then concentrated to commercial strength via multiple-effect evaporation.

While viable, one drawback of the chromatography step is that a certain amount of product dilution occurs. Concentrating the resulting product to commercial strength, i.e. 45-50 wt %, requires expenditure of capital and energy. Furthermore, the chromatography step is less effective with KOH than it is with NaOH. As a result the product dilution is a larger problem with KOH than NaOH.

An energy efficient process route has been devised for converting the alkali hydroxide from the BED/electrolysis cell to a desired alkali salt, said process not requiring the upfront chromatography purification of the alkali hydroxide or the need for pre-concentrating it to 45-50 wt % strength.

In the process any neutral or near-neutral salt may be made. For example, potassium hydroxide may be reacted with elemental sulfur (S) and oxygen to produce potassium thiosulfate:

2KOH+S+O₂=K₂S₂O₃+H₂O

Other examples include the production of phosphates (e.g. dipotassium hydrogen phosphate) and acetate:

2KOH+H₃PO₄=K₂HPO₄+2H₂O

KOH+CH₃COOH=CH₃COOK+H₂O

Sodium and lithium salts can similarly be made.

The salt solutions thus produced have a pH in the range of ˜3-11. The solutions may then processed to remove the anionic contaminants (e.g. Cl⁻, SO₄⁼) by nanofiltration and/or ion exchange. These steps are simpler than chromatography, and do not result in dilution of the product. The purified salt solution may then be concentrated to commercial strength via evaporation of its water content.

Concentration of the salt solutions is generally easier and requires less energy than concentrating the starting alkali hydroxide solution. Many of the salt solutions have relatively low boiling point elevations, thus allowing the use of mechanical vapor recompression (MVR), a more energy efficient method than conventional multiple effect evaporation. Overall energy consumption is thereby reduced significantly and the resulting products are environmentally safe to handle, transport and store.

### DETAILED DESCRIPTION OF THE PREFERRED EMBODIMENTS

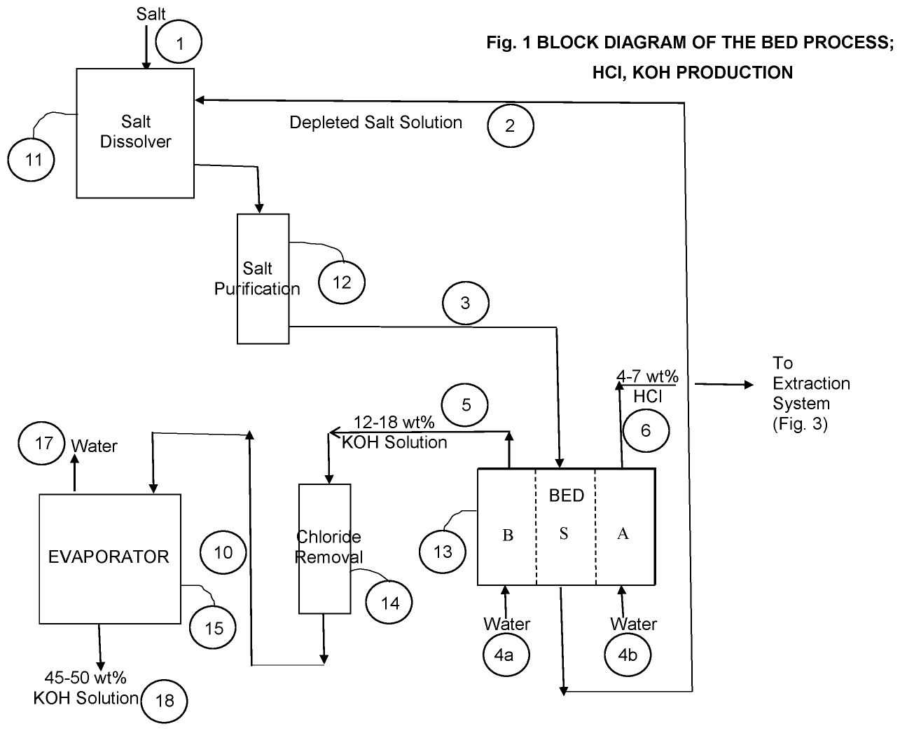

FIG. 1-3 show block diagrams of the process for producing potassium hydroxide and calcium chloride. Referring to FIG. 1, feed salt KCl (potassium chloride, Stream 1) is dissolved in the recycle depleted salt solution, stream 2, in a dissolver unit 11. The resulting (nearly) saturated salt solution is purified through pH adjustment/precipitation and filtration (not shown in the drawing) and further purified in a chelating resin ion exchange column 12 to remove contaminants such as calcium and magnesium. The procedure for salt purification is akin to that practiced commercially in the chlor-alkali process.

The purified salt solution (Stream 3) is then processed in a three-compartment water splitter (BED) unit 13a.

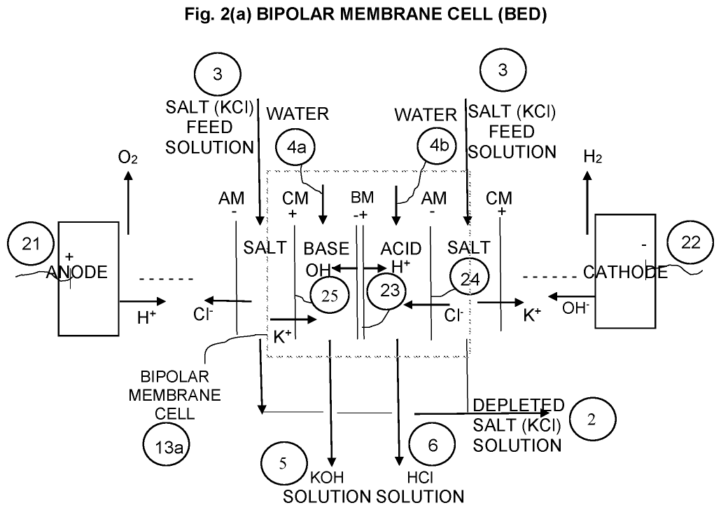

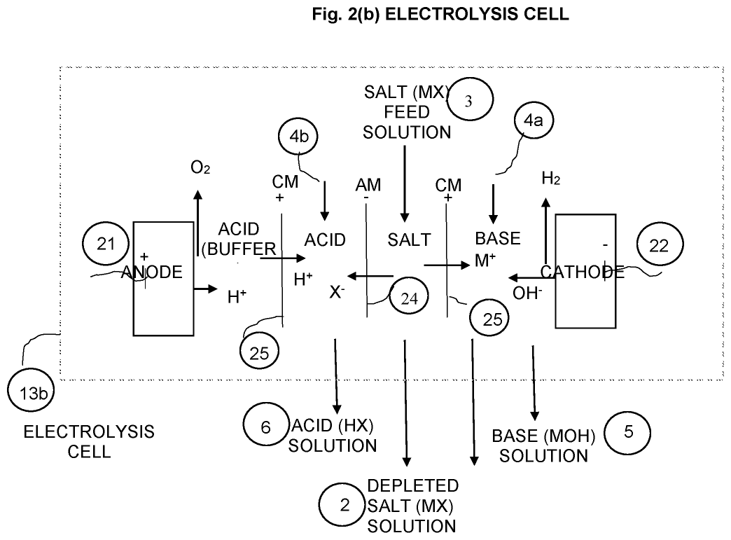

An electrolysis unit 13b, such as shown in FIG. 2(b), can be used in place of the BED unit 13a.). More details on the electrolysis process can be found in the literature.

The water splitter unit 13a, also termed bipolar membrane electrodialysis (BED) unit, is shown in greater detail in FIG. 2(a).

As shown in FIG. 2(a) the BED unit comprises a sequence of bipolar (BM or −+) membranes 23, cation selective (CM or +) membranes 25 and anion selective (AM or −) membranes 24. The membranes are separated by the acid, base and salt solution compartments as shown. The assembly comprising a set of 3 membranes and 3 compartments is termed a bipolar membrane cell or unit cell. 50-150 such unit cells may be assembled between an anode electrode (+) 21 and a cathode electrode (−) 22 to form an electrodialysis cell stack (BMCS) 13a. The purified salt solution, e.g. potassium chloride (KCl), stream 3, is supplied to the salt compartments in the cell stack, while solutions comprising water, streams 4b, 4a are supplied to the acid and base compartments respectively. Distribution of the solutions to the individual compartments is achieved via a set of internal feed manifolds (not shown).

Under an applied direct current driving force, water molecules are forcibly dissociated to the hydrogen (H⁺) and hydroxyl (OH⁻) ions by the bipolar membranes (BM). Simultaneously the potassium (K⁺) and chloride (Cl⁻) ions from the dissociation of salt (KCl) are transported across the cation (CM) and anion (AM) membranes respectively and into the base and acid compartments as shown. The net result is the rearrangement and separation of salt and water to the base (KOH) and acid (HCl) products:

KCl+H₂O→KOH+HCl

Similar processes occur with salts such as NaCl, LiCl, Na₂SO₄:

NaCl+H₂O→NaOH+HCl

LiCl+H₂O=LiOH+HCl

Na₂SO₄+2H₂O→2NaOH+H₂SO₄

Other cell stack arrangements may be used to generate a different blend of the acid, base products. For example a two compartment cell comprising bipolar and cation membranes may be used generate a base product and a mixture comprising acid and salt. This arrangement is suitable for converting a salt such as sodium sulfate (Na₂SO₃) to sodium hydroxide (NaOH) and a mixture comprising sulfuric acid (H₂SO₄) and sodium sulfate. The acid concentration in the acid/salt mixture is typically ˜10 wt %, but will have substantial amounts of salt (Na₂SO₄); ≥10 wt. %, as illustrated in U.S. Pat. No. 4,504,373 Multi-compartment cells comprising a bipolar membrane and two (or more) cation membrane may be used to generate a base product and acid/salt mixture containing a reduced amount of salt.

FIG. 2(b) shows a version of an electrolysis cell that can be used to produce acid and base (alkali) from salt (generically represented as MX). The cell, 13b, comprises an anode (+) 21, a cathode (−) 22, an anion membrane (AM or −) 24 and two cation membranes (CM or +) 25, in an arrangement as shown. The membranes and electrodes form the acid (HX), base (MOH) and salt compartments as well as an acid buffer (typically sulfuric acid, H₂SO₄) compartment to separate the anode solution (anolyte) from the acid product stream 6. Such an arrangement will allow the processing of chloride salts in the electrolysis cell. The buffer compartment is not needed when processing a sulfate salt.

The inputs, outputs to the electrolysis cell are identical to that for the BED cell 13a shown in FIG. 2(a). U.S. Pat. No. 3,135,673 for example describes the process in detail.

The generation of NaOH and H₂SO₄ from the salt using electrolysis can be described by the following equation:

Na₂SO₄+3H₂O=2NaOH+H₂SO₄+H₂+½O₂

As mentioned earlier, the products from the BED or electrolysis processes are relatively dilute and contain certain amounts of contaminant ions, e.g. K⁺, Na⁺ ions in the acid product and Cl⁻, SO₄⁼ ions in the base product. End-user(s) for the products need to be close by, since transporting the products even over moderate distances is uneconomical due to the large water content.

The water splitting process requires a minimum voltage input of ˜0.83V to effect the separation of water to H⁺ and OH⁻ ions. The electrolysis process results in the production of byproducts hydrogen (H₂) and oxygen (O₂) at the electrodes, and requires a minimum voltage of ˜2.1V.

The water splitter (BED) is capable of producing, for example with KCl, 12-18 wt % KOH and 5-7 wt % HCl at a current density of 800-1,000 A/m², cell unit voltage of 2-2.5V and current efficiencies of 70-85%. (Current efficiency is defined as the equivalent of KOH/HCl generated per faraday of current input). Membranes for the process are available commercially from companies such as Astom Corporation, 6-2, Nishi-Shinbashi 2-chome, Minato-ku, Tokyo, Japan; Fumatech BWT GMBH, Carl-Benz-Strasse 4, D-74321 Beitingheim-Bissingen, Germany; AGC Engineering, Membrane Div, Selemion group, Japan; DuPont Co., Wilmington, Del., and others.

The acid and base products, streams 6 and 5 respectively, are withdrawn from the BED (or electrolysis) cell stack and forwarded to downstream recovery/purification steps.

Production of acid and base results in a depletion of salt in the salt loop. The depleted salt solution, stream 2 is recycled back to the salt dissolver unit 11 for re-saturation with fresh salt, stream 1.

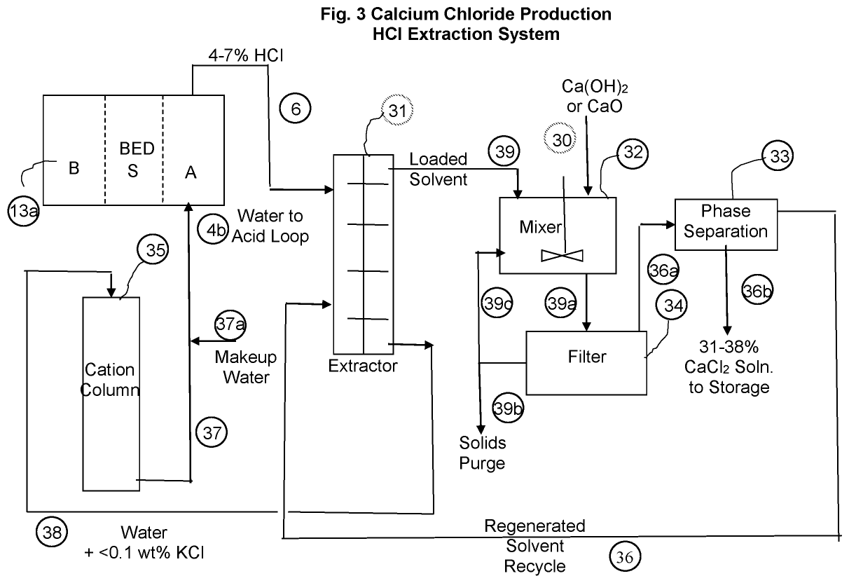

The HCl stream (Stream 6), containing 4-7 wt % HCl, is sent to the extraction system (see FIG. 3) for conversion to the calcium chloride product. Other chloride products can be made in a similar manner.

The alkali metal hydroxide stream, KOH, stream 5 is purified to remove most of the chloride ions in a chromatography column 14. Details on its operation can be found in U.S. Pat. No. 6,482,305 B1. The purified KOH solution, stream 10, substantially reduced in its chloride content is then concentrated in a triple effect evaporator 15 to 45-40 wt % strength, and withdrawn as stream 18. Water is recovered from the evaporator as stream 17 and may be recycled to the BED process.

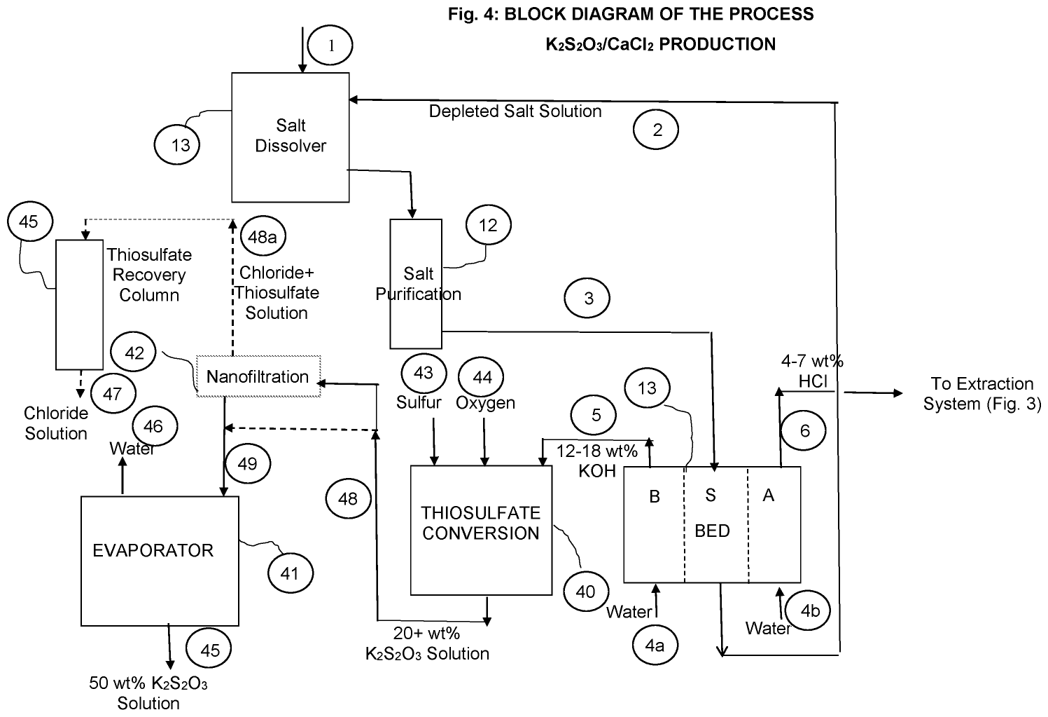

Options for producing alkali compounds that do not require the upfront purification or concentration of the alkali from the BED process have been devised (see FIG. 4). These are outlined in a later part of this disclosure.

Processing the Acid (HCl, H₂SO₄)

The dilute acid (e.g. ˜4-7 wt % HCl) from the water splitter, stream 6, is forwarded to the solvent extraction step.

Details of the solvent extraction system are shown schematically in FIG. 3. The dilute acid, stream 6, from the BED stack 13, is contacted with the regenerated solvent, stream 36, in a (preferably) countercurrent operation in an extractor 31. The extractor unit 31 might comprise a single countercurrent flow unit as shown or a set of continuous stirred tanks (CSTs), with material overflowing from one tank to the next. The solvent typically comprises a water insoluble amine comprising 18-24 carbon units. Examples of suitable amines are tri-capryl amine, tri lauryl amine,), tris (2-ethylhexyl) amine (TEHA), tri dodecyl amine or mixtures thereof such as Alamine 304-1, Alamine 336 sold by BASF; quaternary amines such as Aliquat 336, and others such as ionic liquids (Cyphos 104), tributyl phosphate etc. To improve the extraction ability/kinetics, the solvent is diluted typically with a long chain alcohol such as 1-octanol, n-decanol, 2, 6 dimethyl 4-heptanol (DMH), kerosene, etc. or mixtures thereof.

Any type of extractor unit may be used, such as one or more stirred tanks or a once-through countercurrent unit.

In the extractor unit 31 the acid (HCl) values are extracted into the organic phase. Depending on the amount of solvent mixture used, substantially all of the acid values can be extracted into the organic phase, leaving behind a raffinate (stream 38) comprising water and small quantities of unextracted acid, typically at a pH of ˜4. An additional benefit of the extraction process is that the small quantities of salt/cations, for example the potassium (K⁺), that may be present in the acid (due to the imperfect selectivity of the bipolar membrane BM) are also effectively left behind in the raffinate.

The acid-laden solvent. Stream 39, is withdrawn from the extractor and reacted with quicklime (CaO) or hydrated lime (Ca(OH)₂), stream 30, in a mixer (solvent stripper) unit 32. Limestone (calcium carbonate, CaCO₃) may be used in place of lime. The use of limestone will however result in generation of carbon dioxide gas as a byproduct.

Any type of stripper unit may be used, such as one or more stirred tanks or a once-through countercurrent unit. Since the stripping operation is exothermic, provision needs to be made for cooling the solution.

Depending of the quality of lime used there may be small amounts of insolubles in the output from the mixer unit 32, which is withdrawn as stream 39a.

Stream 39a is filtered in filter unit 34 to remove the insolubles. The solids are purged from the filter as stream 39b. If there are significant amounts of unconverted lime present in the filter purge, the solids may be recycled (stream 39c) back to the mixer unit 32 to improve lime utilization.

The liquid stream (stream 36a) from the filter unit 34 is sent to a phase separator (settler unit) 33. Therein the aqueous and organic phases are separated via gravity settling or the use of centrifugal force. Calcium chloride (CaCl₂) at a concentration, typically of 31-38 wt % (stream 36b) is recovered in the bottom aqueous phase, while the organic solvent in its substantially pure form is recovered as the top layer, stream 36, and forwarded to the HCl extractor unit 31.

The mixer and settler units may be combined into a single unit for continuous stripping of the acid-laden solvent.

Raffinate from the unit 31 comprising water, unextracted acid and the non-extracted salt, e.g. KCl, stream 38, may be sent to a cation exchange column 35. Column 35 comprises a cation exchange resin, typically a strong base resin such as Dowex 50 or IR120 in the hydrogen (H⁺) form. (A weak base resin may also be used instead.) In the resin column the potassium ions (K⁺) in the KCl are replaced by hydrogen ions (H⁺), resulting in the conversion of KCl to HCl. The resulting solution, stream 37, may be combined with any makeup water (stream 37a) and returned as stream 4(b) to the acid loop of the BED unit 13a.

If needed, the raffinate stream 38 may be processed through a separator (e.g. nanofilter, not shown in FIG. 3) to remove the small amounts of solvent that maybe present therein, before being sent to the cation column 35. The recovered solvent from said separator may be combined with the regenerated solvent stream 36, and (along with any makeup solvent) returned to the extractor unit 31.

When the cation column 35 is fully loaded with the potassium ion, it is taken out of the loop and regenerated with HCl. The HCl requirement for this can be from the BED unit. The regeneration step places the column 35 back in the H⁺ form for reuse.

The use of lime (CaO) or hydrated lime (Ca(OH)₂) is just one example of the use of an alkali to convert the dilute HCl to concentrated salt solutions. In principle any base material may be used to produce its salt solution at a high concentration. Examples include the use of lysine to convert to lysine hydrochloride, lithium hydroxide or lithium carbonate to lithium chloride, magnesium hydroxide to magnesium chloride.

Other examples of salts that can be produced are: aluminum chloride, zinc chloride, ammonium chloride, etc.

Dilute sulfuric acid from the BED (or electrolysis) cell may be similarly recovered as sulfate salts such as ammonium sulfate and others. The presence of a significant amount of sulfate salt (as would be the case when a two-compartment cell with bipolar and cation membranes were used) would not be a problem, since the extraction process selectively removes the acid, while leaving the salt component behind.

People skilled in the art will be able to devise modifications to process layout and arrive at other examples of salts that can be obtained using the disclosures made herein.

### Processing the Base (NaOH, KOH)

The KOH (or NaOH) product from the water splitter, stream 5, typically has ˜1,000-2,000 ppm of chloride present. The presence chloride in the alkali product is due to the less than perfect selectivity of the membranes as well as any small amounts of leaks that may be present within the cell stacks.

FIG. 4 shows the process for converting the KOH from the BED process to potassium thiosulfate (K₂S₂O₃). The KOH product (e.g. 12-18 wt. % KOH) from BED cell stack 13a (or electrolysis cell 13b) is forwarded to the thiosulfate conversion unit(s). The thiosulfate conversion unit 40 might comprise one or more reactors in series. The reactors may be of the once-through (plug flow) type or a set of one to three continuous stirred tanks. The reactors have provision for heating and cooling (temperature control) and be able to operate under pressure of ˜70 psig (˜500 kPa-gauge) or so, and equipped with suitable stirrers to ensure adequate mixing and gas liquid contact/distribution.

Conversion of KOH to K₂S₂O₃ occurs through the addition of near stoichiometric amounts of elemental sulfur (S) and oxygen (O₂). The sulfidation and the subsequent reaction with oxygen to thiosulfate may take place in two separate steps. The overall reaction is:

2KOH+2S+O₂=K₂S₂O₃+H₂O

Careful control of operating conditions, e.g. temperature (typically <100° C.), reactant addition, pressure and reaction time are required to ensure that the thiosulfate product is produced with a minimum amount of byproducts such as dithionate (K₂S₂O₄), sulfate (K₂SO₄) etc. Thiosulfate production using concentrated (45-50 wt. %) KOH is well known (see e.g. US Patent Application 2017/0190576 A1) and is practiced by a number of firms. The use of the more dilute KOH, such as that from the BED process (presently not practiced) has excellent reaction kinetics to make the product.

Alternatively the thiosulfate may be made through reaction of KOH with sulfur dioxide (SO₂) to initially generate potassium sulfite (K₂SO₃). The potassium sulfite is then reacted with elemental sulfur to produce the thiosulfate:

2KOH+SO₂=K₂SO₃+H₂O

K₂SO₃+S=K₂S₂O₃

The output from the thiosulfate conversion unit 40, stream 48, comprises (typically) 20+ wt. % potassium thiosulfate, along with minimal levels (typically <2-3 wt %, preferably ˜0.5 wt % or less) of sulfate and other byproducts. Any chloride in the feed KOH will exist in the thiosulfate product, typically amounting to <0.3% KCl. Stream 48 maybe concentrated in the evaporator unit 41 to 45 to 50 wt % K₂S₂O₃ and recovered as stream 45. The concentration step will reduce the contaminants (chloride/sulfate) to negligible levels through their precipitation.

If desired, nearly complete removal of chloride from the dilute thiosulfate product (stream 48) can be attained through nanofiltration (Unit 42) of the potassium thiosulfate product. KCl, being a smaller size monovalent species, is thereby separated from the larger, divalent thiosulfate. One or two stage nanofiltration may be used to achieve chloride removal of up to 99%, along with up to 99% retention of the thiosulfate.

The waste solution from the nanofiltration step, stream 48a, contains the recovered chloride along with some thiosulfate. This solution can be treated in an ion exchange column 45 to recover the thiosulfate values, using an anion resin such as Amberlite IRA 402 in hydroxyl (OH⁻) form. The effluent solution, stream 47, a chloride solution, may be discarded or deionized and reused in the process. When column 45 is fully loaded with the thiosulfate, it can be regenerated using the KOH from the BED, and the effluent comprising thiosulfate and KOH may be recycled to the thiosulfate conversion unit 40.

The purified thiosulfate solution from the nanofiltration step, stream 49, is processed in the evaporator 41 to the commercial strength of ˜50 wt %, and recovered as stream 45.

The water evaporated in the process, stream 46 can be reused elsewhere.

Since the boiling point elevation for the potassium thiosulfate solution is low (the 50 wt % solution has a boiling point of 106° C., vs. 100° C. for water), a mechanical vapor recompression (MVR) evaporator may be used, wherein the concentration of the thiosulfate solution can be achieved at about one third (⅓) the cost involved in concentrating the starting ˜15 wt % KOH to 45-50 wt %.

Dipotassium hydrogen phosphate (K₂HPO₄), DKP, can be made in a similar manner. DKP, is simpler to produce than the thiosulfate, since only a neutralization step is involved. If desired, nanofiltration may be used to remove the chloride from the phosphate product. The boiling point elevation of K₂HPO₄ solution is similar to that of potassium thiosulfate, and therefore can be concentrated using MVR.

Other salts such as sodium phosphates, potassium acetate (CH3COOK), etc. can also be made via neutralization of the NaOH, KOH from the BED process. For salts of monovalent ions such as the acetate, chloride removal can be achieved via ion exchange. Salt solutions with significant boiling point elevation would require conventional (double or triple effect) evaporation to make the products at commercial strength.

Persons skilled in the art will be able produce other salts of sodium, lithium and potassium by following the information presented in this disclosure.

### EXPERIMENTAL RESULTS

The extractive recovery of HCl and its conversion to calcium chloride is illustrated further by reference to the following examples, the details of which should not be construed as limiting the invention except as may be required by the appended claims.

Several trials on converting the dilute HCl to a concentrated calcium chloride solution were carried out. In each of the extraction trials ˜150 ml of ˜7 wt % hydrochloric acid was used; representing the acid product from the BED (or electrolysis) cell stack. Conductivity of the acid was ˜570 mS/cm. For each trial the acid solution was mixed thoroughly with a measured volume of the solvent mixture for ˜30 minutes. The mixture was then phase separated in a separatory funnel. The aqueous raffinate phase was drained first from the bottom and then the organic phase. pH and electrical conductivity of aqueous phase (i.e. the raffinate) were measured in order to establish the extent of HCl transfer into the solvent phase.

The recovered solvent phase was then mixed with a measured (approximately stoichiometric) amount of powdered hydrated lime, (Ca(OH)₂), and mixed thoroughly for ˜30 minutes. The mixture was subsequently poured into a separatory funnel and the aqueous phase comprising calcium chloride (CaCl₂) drawn off first from the bottom. The top layer in the funnel comprising the regenerated solvent, was collected next and its volume measured. The recovered solvent was reused in certain subsequent trials.

The volume and specific gravity of the recovered calcium chloride solution were measured. A portion of the calcium chloride product solution was weighed, dried at 120° C., and the dried solids weighed thereafter to determine the percentage of solids in the solution.

Table 1 shows a summary of the results. It can be seen that the extraction process generates calcium chloride at a concentration of 31-41 wt %. Conductivity and pH measurements on the raffinate show that HCl extracted from the feed solution is 97-100%. Multiple extractions with the recycled solvent show the solvent loss to be fairly minimal and the solvent's HCl extraction capability to be stable.

TABLE 1

| | | | Volume of | | | | | | Specific | |
|---|---|---|---|---|---|---|---|---|---|---|
| | | | Solvent | Raffinate | | Raffinate | Ca(OH)₂ | CaCl₂ | Gravity of | Wt % |
| Trial | Solvent Mix | Fresh or | Mixture, | Volume, | Raffinate | Conductivity, | Added, | Volume, | CaCl₂ | CaCl₂ in |
| # | Used* | Reused | ml | ml | pH | mS/cm | gm | ml | Solution | solution |
| 1 | Alamine 336- | Fresh | 600 | 132 | 3.43 | 0.44 | 12.83 | 12 | Volume, | 41.6 |
| | 33% + DMH-67% | | | | | | | | ml | |
| 2 | Alamine 336- | Reused | ~600 | 129 | 2.95 | 3.9 | 13.52 | 24 | >1.3 | 35.5 |
| | 33% + DMH-67% | from Trial 1 | | | | | | | | |
| 3 | Alamine 336- | Reused | ~600 | 130 | 3.71 | 1.91 | 12.11 | 24.2 | 1.41 | 36 |
| | 33% + DMH-67% | from Trial 2 | | | | | | | | |
| 4 | Alamine 304-1- | Fresh | 870 | 112 | 6.64 | 0.34 | 13.3 | 26.5 | 1.28 | 32.45 |
| | 33% + 1- | | | | | | | | | |
| | Octanol-67% | | | | | | | | | |
| 5 | Alamine 304-1- | Reused | 902 | 116 | 5.1 | 10.3 | 12.7 | 26.5 | 1.36 | 31~ |
| | 33% + 1- | from Trial | | | | | | | | |
| | Octanol-67% | 4 + 35 ml | | | | | | | | |
| | | makeup | | | | | | | | |
| 6 | Alamine 304-1- | Reused | 900 | 116.5 | 5.18 | 6.6 | 12.8 | 29.5 | 1.29 | 31.4 |
| | 33% + 1- | from Trial 5 | | | | | | | | |
| | Octanol-67% | | | | | | | | | |
| 7 | Alamine 304-1- | Reused | 800 | 120 | 4.26 | 4.22 | 18.23 | 30 | 1.3 | 34 |
| | 33% + 1- | from Trial 6 | | | | | | | | |
| | Octanol-67% | | | | | | | | | |
| 8 | Alamine 304-1- | Reused | 800 | 119 | 5.11 | 14 | 15.72 | 28.5 | 1.3 | 35 |
| | 33% + 1- | from Trial | | | | | | | | |
| | Octanol-67% | 7 + 15 ml | | | | | | | | |
| | | makeup | | | | | | | | |
| 9 | Alamine 304-1- | Reused | 765 | 121 | 11.04 | 11 | 13.1 | 27.5 | 1.3 | 33.3 |
| | 33% + 1- | from Trial 8 | | | | | | | | |
| | Octanol-67% | | | | | | | | | |
| 10 | Alamine 304-1- | Reused | 800 | 120 | 4.6 | 9.3 | 14.4 | 32 | 1.3 | 35.9 |
| | 33% + 1- | from Trial 9 | | | | | | | | |
| | Octanol-67% | | | | | | | | | |

*Alamine 304-1 is tri-n-dodecyl amine; Alamine 336 is trioctyl/decyl amine DMH: 2, 6 Dimethyl 4-Heptanol

1. A process for converting a dilute acid solution through extraction of the acid values into an organic solvent mixture, whose active component comprises a long chain amine of 18-24 carbon atoms, followed by stripping the loaded solvent with a suitable alkali; thereby generating a salt product at a higher concentration than that of the acid extracted.

2. The process of claim 1 wherein the acid is hydrochloric acid and the solvent used comprises an 18 to 24 carbon chain amine diluted with an 8 to 10 carbon chain alcohol and/or kerosene.

3. The process of claim 1 wherein the acid is sulfuric acid and the solvent used comprises an 18 to 24 chain amine diluted with an 8 to 10 carbon chain alcohol and/or kerosene

4. Process of claim 1 wherein the acid extracted is hydrochloric acid, the alkali used is lime, hydrated lime or calcium carbonate and the salt generated is calcium chloride

5. Process of claim 1 wherein the acid extracted is at a concentration of 3-12 wt % and the chloride or sulfate salt generated is at 25-39 wt % strength

6. Process of claim 1 wherein the acid extracted is hydrochloric acid, the alkali used is lysine and the product generated is lysine hydrochloride

7. Process of claim 1 wherein the solvent used comprises tricapry amine, tri-octyl amine, tri-decyl amine, tri-dodecyl amine, tri-lauryl amine, mixed long chain amines such as Alamine 304-1, Alamine 336, trioctyl phosphine oxide (TOPO), and ionic liquids such as Cyphos 104 and a diluent that comprises 1-octanol, 2, 6 dimethyl 4-heptanol and/or kerosene.

8. Process of claim 1 wherein the acid extracted is hydrochloric acid, the alkali used is lithium carbonate or lithium hydroxide and the salt generated is lithium chloride.

9. Process of claim 1 wherein the acid extracted is sulfuric acid, the alkali used is ammonia or ammonium hydroxide and the salt generated is ammonium sulfate.

10. Process of claim 1 wherein the hydrochloric acid used is generated from a chloride salt using a bipolar membrane cell stack or electrolysis cell stack, said process driven by a direct current driving force, and generating alkali metal hydroxide as a co-product.

11. Process of claim 1 wherein the sulfuric acid used is generated from a sulfate salt using a bipolar membrane cell stack or electrolysis cell stack, said process driven by a direct current driving force, and generating alkali metal hydroxide as a co-product.

12. A process for producing a chloride or sulfate salt and alkali metal hydroxide comprising:
a. Converting an alkali chloride or sulfate salt to the corresponding acid and alkali metal hydroxide by processing in an electrodialysis cell or electrolysis cell
b. Converting the acid product to a different salt than the starting chloride or sulfate salt by extracting the acid with a solvent comprising a long chain amine of 18-24 carbon atoms and stripping the solvent mix with an alkali so as to produce a salt that is different from the starting chloride or sulfate salt and regenerating the solvent
c. Purifying the alkali metal hydroxide from step (a) via chromatography to substantially remove the contaminant anion

13. Process of claim 12 wherein the solvent used is a tricapry amine, tri-octyl amine, tri-decyl amine, tri-dodecyl amine, tri-lauryl amine, mixed long chain amines such as Alamine 304-1, Alamine 336, trioctyl phosphine oxide (TOPO), and ionic liquids such as Cyphos 104

14. Process of claim 12 wherein the solvent mix has a long chain alcohol comprising 8-10 carbon atoms and/or kerosene as diluent.

15. Process of claim 12 wherein the alkali salt converted is sodium chloride, potassium chloride; the salt produced is calcium chloride, lysine hydrochloride, lithium chloride and the alkali produced is sodium hydroxide, potassium hydroxide or lithium hydroxide.

16. A process for producing a chloride or sulfate salt and an alkali metal salt comprising:
a. Converting an alkali chloride or sulfate salt to the corresponding acid and alkali metal hydroxide by processing in an electrodialysis cell or electrolysis cell
b. Converting the acid chloride or sulfate salt by extracting the acid with a solvent comprising a long chain amine of 18-24 carbon atoms and stripping the solvent with an alkali so as to produce a salt that is different from the starting chloride or sulfate salt and regenerating the solvent
c. Reacting the alkali hydroxide with an acidic component to produce the alkali metal salt other than the starting chloride or a sulfate

17. Process of claim 16 wherein the solvent used comprises tricapry amine, tri-octyl amine, tri-decyl amine, tri-dodecyl amine, tri-lauryl amine, mixed long chain amines such as Alamine 304-1, Alamine 336, trioctyl phosphine oxide (TOPO), and ionic liquids such as Cyphos 104 and diluted with a long chain alcohol of 8 to 10 carbon atoms and/or kerosene, and the salt produced is calcium chloride, lysine hydrochloride or lithium chloride

18. Process of claim 16 wherein the alkali chloride salt converted is potassium chloride or sodium chloride and the alkali metal salt produced is potassium thiosulfate or sodium thiosulfate

19. Process of claim 16 wherein the alkali chloride salt converted is potassium chloride or sodium chloride and the alkali metal salt produced is potassium phosphate, sodium phosphate, sodium acetate or potassium acetate.

20. Process of claim 16 wherein the alkali sulfate salt is sodium sulfate or potassium sulfate and the alkali produced is ammonium sulfate.
